(19) United States
(12) Patent Application Publication
(10) Pub. No.: US 2008/0250588 A1
(43) Pub. Date: Oct. 16, 2008

(54) Multi-purpose bathroom cleaning tool

(75) Inventors: Christopher L. Robinson, Ravenna, OH (US); Michael J. Maczuzak, Bratenahl, OH (US); Aaron D. Marshall, Uniontown, OH (US); Bryan Neidert, North Royalton, OH (US); Mary K. Vieram, North Royalton, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Waxman Consumer Products Group Inc., Bedford Hts., OH (US)

(21) Appl. No.: 11/786,181

(22) Filed: Apr. 11, 2007

(51) Int. Cl. B08B 13/00; A46B 15/00

(52) U.S. Cl. 15/104.05; 15/143.1

(57) ABSTRACT

A multi-purpose apparatus used for cleaning and removing debris from plumbing comprising a handle assembly having first and second ends, the first end includes a handle section for grasping by an operator. A trigger assembly is operatively located within the handle section for actuation by the operator and a receiving assembly is located within the handle assembly at the second end. The receiving assembly includes a pair of gripping arms. The multi-purpose apparatus further includes a working head having an attachment end and a working end. The attachment end has a head including a reduced diameter, chamfered portion for engagement by the gripping arms to hold the working head and the handle assembly portion in a locking connection.

### FIELD OF THE INVENTION

The present invention relates to a multi-purpose bathroom cleaning tool generally, and more specifically a multi-purpose bathroom cleaning tool having a handle assembly selectively attachable to a selected one of a plurality of working heads.

### BACKGROUND OF THE INVENTION

A myriad of bathroom cleaning tools are available to consumers. In addition to cleaning brushes and sponges, bathrooms typically require a plunger for removing clogs and debris from sink drains and toilets. Traditional toilet bowl plungers, sponges, brushes, and the like, pose hygienic problems since the working head, such as the plunger, sponge, or brush is frequently exposed to bacteria and fungi during use. Further, since a number of different cleaning tools are typically utilized in cleaning, for example, a bathroom, e.g., a toilet plunger, a toilet brush, a sponge, one or more abrasive or soft cleaning cloths for cleaning sinks, shower walls, mirrors, etc. The increasing number of cleaning tools leads to increased storage space requirements, especially given the limited storage space found in typical bathrooms.

What is desired, therefore, is a multi-purpose cleaning tool wherein a single handle assembly may be selectively mated to a plurality of working heads to reduce storage space requirements. What is also desired is for the selected working head to be easily attachable and detachable from the handle assembly. What is also desired is for the working head to be detachable without the necessity of touching the working head, which may be soiled after use thereby reducing the possibility of spreading germs and bacteria to the user or operator of the tool.

### SUMMARY OF THE INVENTION

The present invention relates to a multi-purpose cleaning tool having a plurality of working heads used for both cleaning purposes and for removing debris from plumbing fixtures such as a toilet or sink. The tool includes a quick-connect attachment mechanism that facilitates secure attachment of a handle assembly to a selected one of a plurality of working members or heads and permits one-handed detachment of the selected working head from the handle assembly.

The tool comprises a handle assembly having first and second ends, the first end includes a handle section for grasping by an operator. The attachment mechanism includes a trigger assembly operatively located within the handle section for actuation by the operator and a receiving assembly located within the second or receiving end of the handle assembly. The receiving assembly includes a pair of gripping arms. The multi-purpose tool further includes a working head having an attachment end and a working end. The attachment end, which is part of the attachment mechanism, is configured to be engaged by the gripping arms of the receiving assembly to secure the working head to the handle assembly in a locking connection.

The present invention also relates to a multi-purpose cleaning tool having a handle member and a working member. The handle member receives the working member in a locking connection in an attached condition and the handle member freely releases the working member in a detached condition. The handle member has a first and a second end, the first end includes a gripping section for holding the cleaning tool by an operator and a trigger assembly being operatively located near the gripping section. The working member includes a working end and an attachment assembly spaced opposite the working end. A receiving assembly is positioned at the second end of the handle member for connecting with the attachment assembly. The receiving assembly includes a pair of pivotally connected gripping arms connected to the trigger assembly through a link connection.

The present invention further relates to a hand-held multi-purpose cleaning and plunging tool for use by an operator for cleaning and/or unclogging debris from a drain comprising a first member having a receiving assembly, handle section, and a trigger assembly. The trigger assembly is located within the handle section. A second member has an attachment end and a working end and when assembled the attachment end engages the receiving assembly of the first member to form a locking connection with the second member. A central link operatively connects the trigger assembly to the receiving assembly along a body segment of the first member. The receiving assembly includes a first and a second pivotally mounted gripping arm. The gripping arms include fingers for engaging the attachment end. The receiving assembly further includes a hub having an upper and lower portion, the upper portion is connected the central link and the lower portion is pivotally connected to the gripping arms. Also within the receiving assembly is a projection stop extending from the lower portion of the hub for engaging the attachment end. A polygonal shaped aperture is located in the receiving assembly for uniting with the attachment end. A pair of cylinders are integrally connected to the gripping arms and hub such that actuation of the trigger assembly in a first direction causes translation of the central link resulting in outward pivotal movement of the gripping arms. A circular head and polygonal projection extend from the attachment end. The polygonal projection engages the polygonal shaped aperture forming an anti-rotational connection. The gripping arms engage the circular head to form the locking connection between the first and second members.

### BRIEF DESCRIPTION OF THE DRAWINGS

The foregoing and other features and advantages of the present invention will become apparent to one skilled in the art to which the present invention relates upon consideration of the following description of the invention with reference to the accompanying drawings, in which:

FIG. 1 is a perspective view of an example embodiment of a multi-purpose cleaning tool;

FIG. 2 is an elevated view of one example embodiment of a working head in the form of a plunger;

FIG. 3A is a sectional view of a handle section taken generally along line 3A-3A in FIG. 1;

FIG. 3B is an magnified sectional view of FIG. 3A depicting a trigger assembly of a multi-purpose cleaning tool;

FIG. 3C is an magnified sectional view of FIG. 3A depicting a receiving assembly of a multi-purpose cleaning tool;

FIG. 4 is an end view of the handle section of FIG. 3A taken generally along line 4-4;

FIG. 5A is an elevated view of an attachment assembly located on an example embodiment of a multi-purpose cleaning tool;

FIG. 5B is an elevated view of an attachment assembly for an example embodiment of a multi-purpose cleaning tool;

FIG. 6 is an assembly view illustrating a receiving assembly engaged with an attachment assembly for an example embodiment of a multi-purpose cleaning tool;

FIG. 7A is perspective view of one example embodiment of a working head in the form of a brush assembly;

FIG. 7B is an assembly view of the working head brush assembly of FIG. 7A;

FIG. 8A is a perspective view of one example embodiment of a working head in the form of a cleaning sponge assembly;

FIG. 8B is an assembly view of the working head sponge assembly of FIG. 8A;

FIG. 9A is a sectional assembly view illustrating an example embodiment of a receiving assembly and an attachment assembly a multi-purpose cleaning tool; and

FIG. 9B is a sectional assembly view of one example embodiment of a working head in the form of a plunger assembly.

### DESCRIPTION OF THE PREFERRED EMBODIMENTS

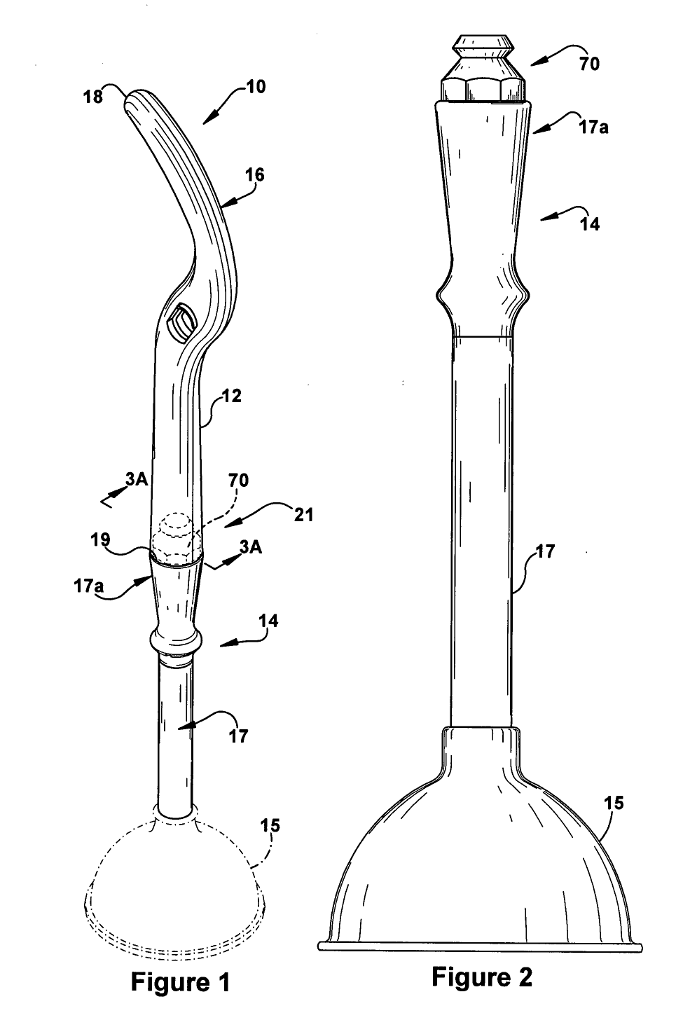

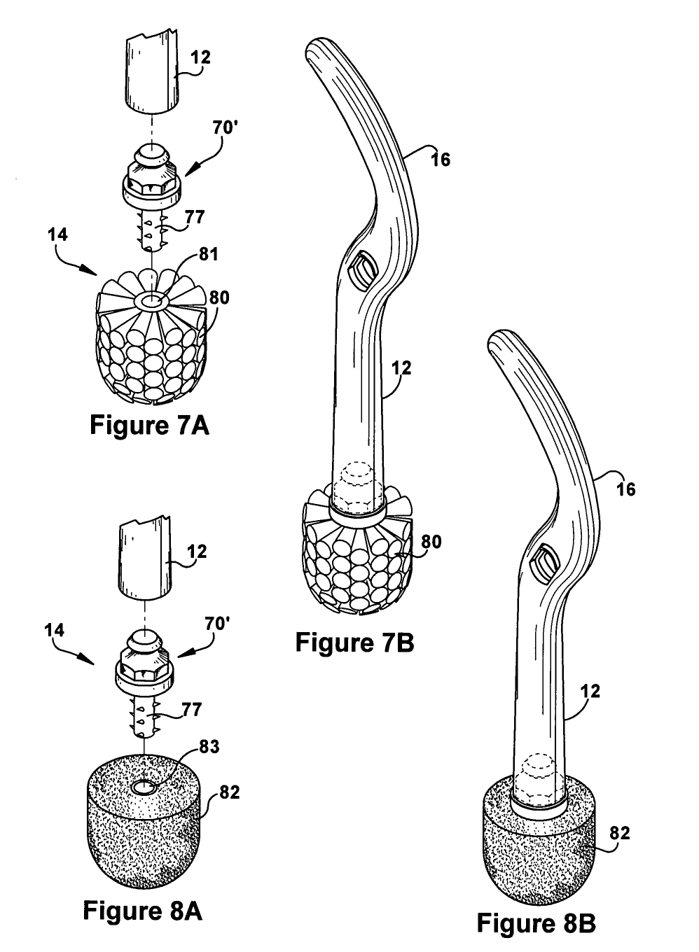

An apparatus 10 illustrated in FIG. 1 is a multi-purpose cleaning tool including a handle assembly 12 removably coupled to a working head 14. The handle assembly 12 is advantageously configured to be easily and quickly attachable and detachable from a selected one of a plurality of working heads 14. Each working head 14 includes a working member 15 and a shaft 17. The working member 15 may be any of a variety of debris removing and/or cleaning tools, for example, a plunger for unclogging sink drains and/or toilets, a sponge, a cleaning brush, a disposable cleaning cloth removably held in a holder, etc. Exemplary working heads 14 include a toilet plunger 15 (FIG. 2) for clearing plumbing obstructions/debris found in, for example, toilet and sink drains, a brush 80 (FIG. 7A) and a sponge 82 (FIG. 8B).

The handle assembly 12 comprises a handle housing 12a and includes a handle section 16 having a gripping end 18 to be held by an operator's hand during use. Located opposite the gripping end 18 of the handle assembly 12 is a receiving end 19 that receives the working head 14. The apparatus 10 is made primarily of plastic but could be made from an unlimited number of other suitable materials without departing from the spirit and scope of the claimed invention. For example, rubber or metals could be used as an alternative or in combination with plastic, e.g., the working member shown in FIG. 2, i.e., the plunger working member 15 may be fabricated of a rubber composition for increased flexibility while the handle assembly 12 may be fabricated of a hard, high impact, lightweight plastic.

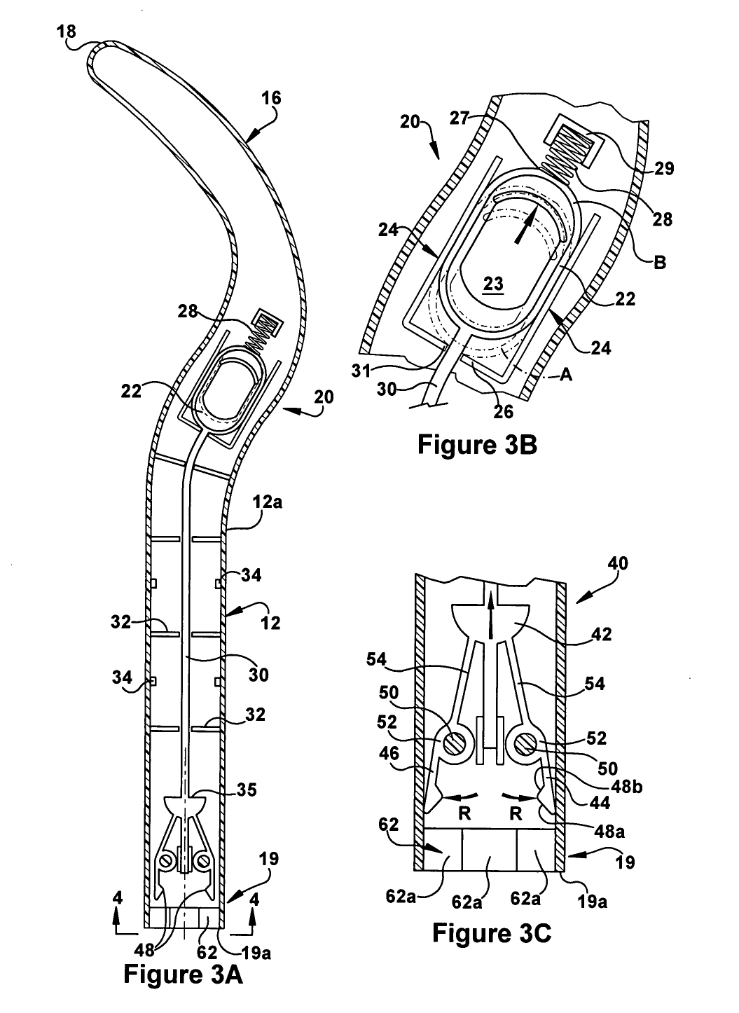

Illustrated in FIG. 2 is an enlarged view of the working head 14 comprising the working member 15 and a shaft 17. In the embodiment of FIG. 2, the working member comprises the plunger 15 connected to the shaft 17. The working head 14 has been separated from the handle assembly 12 of FIG. 1. FIG. 3A depicts a sectional view of FIG. 1 generally along line 3A-3A of the handle assembly 12 with the working head 14 removed. The sectional view of FIG. 3A reveals a trigger assembly 20 positioned within the handle 16. The trigger assembly 20 is part of a quick-connect attachment mechanism 21 that advantageously facilitates easy attachment and detachment of a selected working head 14 from the handle assembly 12. The attachment mechanism 21 is best seen in FIG. 6. The operator can advantageously detach the working head 14 from the handle assembly 12 without grasping or touching the working head 14 which may have become soiled during use.

The trigger assembly 20 is situated such that when an operator grasps the gripping end 18 with his or her hand, one of their fingers will engage a trigger 22 that operatively releases the working head 14 from the handle assembly 12. The trigger assembly 20 as shown in FIG. 3B includes an aperture 23 for receiving the operator's finger and guides 24 for directing the movement of the trigger 22 from its unactuated or locking position shown at point A (in phantom) to it actuated or release position indicated at point B. The trigger 22 is biased against a stop 26 in its locking position A. The stop 26 is located at one end of the guides 24 and prevents further movement of the trigger 22 in an unactuated condition. A force acting on the trigger 22 is induced by a spring biasing member 28. One end of the spring 28 is retained in a housing 29 that is integrally molded with the handle 26. The opposite end of the spring 28 engages a flat section 27 positioned along the top of the trigger 22. However, other constructions for retaining the spring 28 in contact with the trigger 22, such as a projection extending from the trigger to the inside the spring or an aperture located within the trigger for housing the spring (not shown) could also be used.

The trigger 22 is connected to a central link 30 that passes through an opening 31 located in the stop 26. The central link 30 connects the trigger assembly 20 to a receiving assembly 40 as shown in FIGS. 3A, 3C, 4, and 6. The central link 30 and the receiving assembly 40 are also part of the attachment mechanism 21. The central link 30 extends through a plurality of link guides 32 molded within the handle assembly 12. The link guides 32 aid in directing the movement of the central link 30 upon engagement of the trigger 22. The handle assembly housing 12a is cylindrically shaped between two sections that are connected by attachment points 34. Located along the central link 30 at an end opposite the trigger 22 is a connection end 35 that attaches to a hub 42 of the receiving assembly 40. Integrally connected with the hub 42 are first and second gripping arms 44 and 46, respectively that are linked to the hub 42 through a pair of cylinders 52 and connecting bands 54. The gripping arms 44, 46 include a catch 48 for forming a locking connection with the working head 14.

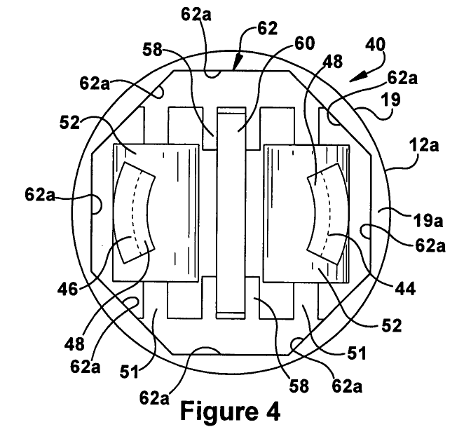

The cylinders 52 are rotatably connected at first pivot points 50 by a pair of posts 51 integrally molded into the handle assembly housing 12a, as best seen in FIG. 4. FIG. 4 is an end view of the handle section of FIG. 3A taken generally along line 4-4. A pair of second pivot points 56 exists at the union between the hub 42 and connecting bands 54. In the illustrated embodiment, the second pivot points 56 form a live hinge resulting from the flexing of the integral attachment of the connecting bands 54 and hub 42. However, an independent connection could exist between the connecting bands 54 and hub 42 by a ball and socket joint or other known pivotal connections without departing from the spirit or scope of the claimed invention.

FIG. 4 illustrates a pair of bearing surfaces 58 that are integrally molded with the handle assembly 12 and help guide a projection 60, which extends from the hub 42. The gripping arms 44 and 46 are arcuately shaped along with their respective catches 48 for attachment purposes to the working head 14. In the locking position of the trigger 22 (point A in FIG. 3B), the gripping arms 44, 46 are in the closed together or locking position of the arms shown in FIG. 6 to secure the working head 14 to the handle assembly 12. In the actuated or release position of the trigger 22 (point B in FIG. 3B), the gripping arms 44, 46 are pivoted outwardly in a release position to allow release of the working head 14 from the handle assembly 12, as shown in FIG. 3C.

Also designed for securing the working head 14 to the handle assembly 12 is a polygonal shaped receptacle 62 located at the receiving end 19. The polygonal shaped receptacle 82 is part of the quick-connect attachment mechanism 21. In the illustrated embodiment, the polygonal shape receptacle 62 is an octagon.

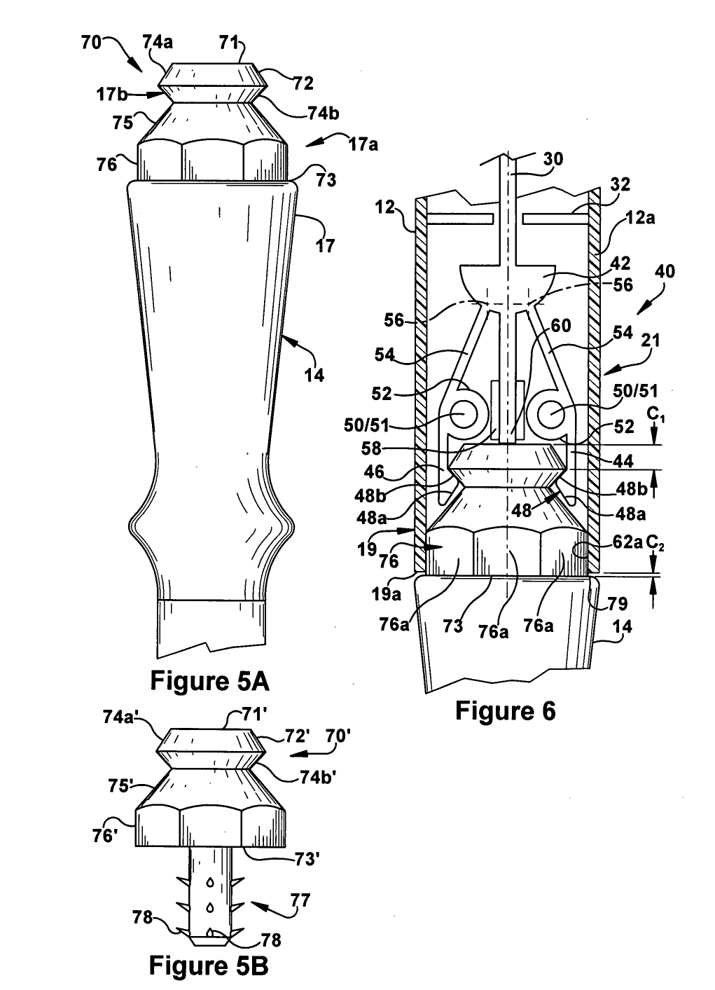

FIG. 5A shows one example embodiment of a working head 14 having attachment assembly or end 70 disposed at an upper end 17a of the shaft 17 for engaging the receiving end 19 of the handle assembly 12. The working head attachment assembly 70 is part of the tool quick-attach attachment mechanism 21. The attachment assembly 70 includes proximal and distal ends 71, 73, the proximal end 71 has a circular head 72 with upper and lower chamfers 74a, 74b. Extending from the lower chamfer 74b is an angled neck portion 75 that extends outwardly to a polygonal projection 76.

The lower chamfer 74b defines a reduced diameter region or section 17b of the shaft upper end 17a and the circular head 72 that is adapted to engage by respective catches 48 of the gripping arms 44, 46 in the locking position of the gripping arms. This can best be seen in FIG. 6. The neck portion 75 that provides spacial relief from the polygonal projection 76 and provides clearance space for the catches 48 when the catches bear against the lower chamfer 74b. The polygonal projection 76 in the illustrated embodiment is octagonally shaped.

When the working head 14 is attached to the handle assembly 12, as can best be seen in FIG. 6, the respective catches 48 of the gripping arms 44, 46 engage and hold against the lower chamfer 74b of the circular head 72 of the working head attachment assembly 70 to prevent downward vertical movement of the working head 14 with respect to the handle assembly 12. Upward vertical movement of the working head 14 with respect to the handle assembly 12 is prevented because downward pressure on the handle eliminates the slight clearance C₁ between an upper stepped edge 79 of the distal end 73 of the attachment assembly 70 and a flat bottom surface 19a of the receiving end 19. When the upper stepped edge 79 contacts the flat bottom surface 19a, further upward vertical movement of the working head 14 with respect to the handle assembly 12 is precluded.

Rotational movement of the working head 14 with respect to the handle assembly 12 is precluded because of the polygonal interfitting of the polygonal projection 76 of the attachment assembly 70 and the polygonal shaped receptacle 62 of the receiving end 19 of the handle assembly 12. Stated another way, faces 76a of the polygonal projection 76 fit snugly against mating faces 62a of the receptacle 62 to prevent rotational movement of the working head 14 with respect to the handle assembly 12.

The receiving end 19 of the handle assembly 12 receives various other working heads 14 in addition to the toilet plunger 15. Such examples include, a brush 80 and sponge 82, which are shown in FIGS. 7 and 8, respectively. It should be appreciated by those skilled in the art that other working heads 14 could be used with the handle assembly 12 without departing from the spirit and scope of the claimed invention.

FIG. 5B is an illustration of a second embodiment of an attachment assembly or end 70′ for a working head 14 that can be adapted to the brush 80 or sponge 82. The second attachment assembly 70′ includes proximal and distal ends 71′, 73′, the proximal end 71′ having a circular head 72′. The head 72′ includes upper 74a′ and lower 74b′ chamfers connected to a neck portion 75′ that provides spacial relief from a polygonal projection 76′. The polygonal projection 76′ in the illustrated embodiment is octagonally shaped. Protruding from the distal end 73′ of the attachment assembly 70′ is a post 77 having a plurality of barbs 78 for securing a corresponding brush 80 or sponge 82 to the attachment assembly 70′.

The joining of the working head 14 and handle assembly 12 is achieved by engaging the attachment assembly 70, 70′ with the receiving assembly 40. The circular head 71, 71′ penetrates the polygonal receptacle 62 in a clearance-like fashion. The polygonal receptacle 62 and the polygonal projection 76 are of the same geometrical configuration and aligned such that engagement can occur between the working head 14 and adapter portion 12. The alignment of the two polygonal geometries 62 and 76 provide an anti-rotational effect once the working head 14 and handle assembly 12 are united. Other polygonal geometries could achieve a similar anti-rotational effect without departing from the spirit or scope of the claimed invention.

The chamfered upper surface 74a, 74a′ influence the movement of the first and second arms 44, 46 in an outward direction upon contacting a lower portion 48a of the catch 48. The outward movement of the arms 44, 46 continues until the arms transition from the upper chamfer 74a, 74a′ to the lower chamfer 74b, 74b′ at which time a locking position is achieved between an upper portion 48b of the catch 48 and the lower chamfer 74b, 74b′ to secure the working head 14 and the handle assembly 12, as depicted in FIG. 6. The connecting tolerance between the adapter portion 12 and working head 14 is controlled by the dimension C₁ shown in FIG. 6. The dimension C₁ is positioned between the projection 60 and catch 48. In particular, sufficient clearance is controlled by reducing or increasing the length of the projection 60, which provides a fixed stop against the circular head 71, 71′. If more clearance is required, the length of the projection 60 is reduced, if less clearance is required the length of the projection is increased.

The dimension C₁ is further controlled such that there is a small clearance dimension C₂ between the proximal end 73, 73′ of the working head 14 and the receiving end 19 of the handle assembly 12 upon achieving the locking position. As noted above, upon downward pressure on the handle gripping portion 18 will cause the clearance dimension C₂ to be reduced to zero as the handle assembly end 19a contacts the stepped portion 79 of the shaft upper end 17a.

The controlled design of the multi-purpose working tool 10 is such that connecting or attaching the handle assembly 12 and working head 14 can be achieved in a quick-connect type fashion, that is, the operator does not have to pull the trigger 22 upwardly to the actuated position B in order to couple the working head 14 to the handle assembly 12. A locking connection is achieved by simply aligning and moving the attachment assembly 70 of the working head 14 into the mating opening of the receiving end 19 of the handle assembly 12. The chamfered upper surface 74a, 74a′ contact the lower portion 48a of the catch 48 of the first and second arms 44, 46 causing the arms to pivot outwardly. The outward movement of the arms 44, 46 continues until the catch 48 transitions from the upper chamfer 74a, 74a′ to the lower chamfer 74b, 74b′ at which time the locking position is achieved between the upper portion 48b of the catch 48 and the lower chamfer 74b, 74b′.

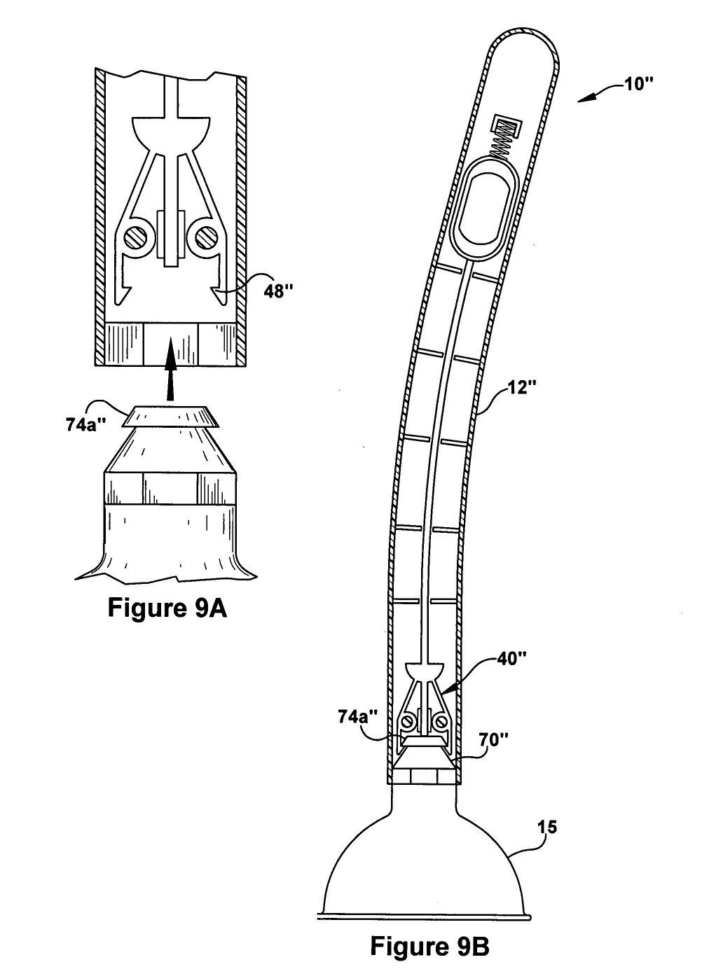

In order to remove or detach the working head 14 from the handle assembly 12, the trigger 22 is engaged by the operator, moving in the direction of the arrow of FIG. 3B against the biasing member 28. The trigger engagement retracts the central link 30 and hub 42 via connection 35 in an upward direction as seen in FIG. 3C. The upward movement of the central link 30 and hub 42 force the first and second arm 44 and 46 to pivot in an outward direction about the cylinders 52 as indicated by the arrows in FIG. 3C obtaining a releasing position R. The working head 14 is released in a “hands-free” fashion, that is, it requires no touching or assistance by the operator as the working head 14 drops freely from the handle assembly 12. The hands-free release operation is facilitated by the corresponding chamfered surfaces of the catch 48 and lower chamfer 74b, 74b′. However, in an alternative embodiment of FIG. 9A, the lower chamfer 74b, 74b′ and chamfered surface along catches 48″ are eliminated, but still providing a quick-connect attachment and hands-free release.

Referring again to FIGS. 7 and 8 are two separate working head 14 example embodiments being the brush 80 and sponge 82. FIG. 7A depicts the brush 80 having an aperture 81 for receiving the post 77 upon insertion of the attachment assembly 70′. The attachment assembly 70′ is then received by the adapter portion 12 in the same quick-connection type fashion as previously discussed above and depicted in FIG. 7B. The brush 80 is released by the operator engaging the trigger 22, thereby releasing the brush and attachment assembly 70′ in the hands-free type fashion previously discussed.

FIG. 8A depicts the sponge 82 having an aperture 83 for receiving the post 77 upon insertion of the attachment assembly 70′. The attachment assembly 70′ is then received by the adapter portion 12 in the same quick-connection type fashion as previously discussed above and depicted in FIG. 8B. The quick-connection reduces the operator's exposure to bacteria and other undesirable content accumulated on the brush during use and facilitates a sanitary disposal of the brush. The sponge 82 is released by the operator's engagement of the trigger 22, thereby releasing the brush and attachment assembly 70′ in the hands-free type fashion previously discussed. This reduces the operator's exposure to bacteria and other undesirable content accumulated on the sponge during use and facilitates a sanitary disposal.

FIG. 9B depicts yet another embodiment in which an adapter portion 12″ is attached directly to a plunger 15 eliminating shaft 17 shown in the earlier example embodiments. In the illustrated embodiment of FIG. 9B, the attachment assembly 70″ is directly connected to both the plunger 15 and receiving assembly 40″. Further benefits of the multi-purpose tool 10 are perceived by the reduction storage space. For example, only one handle assembly 12 is needed that can attach to any number of tools. Without the need of multiple handle assemblies, the various types of working heads 14 can be stored in a much smaller container and replenished after use or being worn.

From the above description of the invention, those skilled in the art will perceive improvements, changes and modifications. For example, other working heads 14 in addition to sponges, brushes, and plungers could be attached to the adapter portion 12 using a similar attachment and receiving assemblies in an unlimited number of household and industrial applications where hands-free release and/or quick-connect attachment is desired. Such improvements, changes and modifications within the skill of the art are intended to be covered by the appended claims.

We claim:

1. A multi-purpose tool comprising:
a handle assembly having first and second ends, said first end having a handle section for grasping by an operator;
a trigger assembly operatively located within said handle section for actuation by an operator;
a receiving assembly located within said handle assembly at said second end, the receiving assembly including a pair of gripping arms coupled to said trigger assembly such that in a first position of said trigger assembly the gripping arms are in a locking position and in a second position of said trigger assembly the gripping arms are in a release position; and
a working head having a working member and an attachment end extending away from the working member, the attachment end including a reduced diameter region engaged by said gripping arms to secure the working head to the handle assembly when the gripping arms are in the locking position.

2. The multi-purpose tool of claim 1 wherein said gripping arms are pivotally connected by a pair of cylinders linked with said trigger assembly such that actuation of the trigger assembly to the second position forces the gripping arms to pivot outwardly about said cylinders to the release position to detach the working head from the handle assembly.

3. The multi-purpose tool of claim 1 wherein said trigger assembly further comprises a biasing member that forces the trigger assembly to the first position and the gripping arms to the locking position.

4. The multi-purpose tool of claim 1 wherein said receiving assembly further comprises a polygonal receptacle and said attachment end further comprises a polygonal projection such that joining said working head with said handle assembly aligns said polygonal receptacle with said polygonal projection to provide an anti-rotational effect when in the locking position between the working head and said handle assembly.

5. The multi-purpose tool of claim 2 wherein said receiving assembly further comprises a polygonal receptacle and said attachment end further comprises a polygonal projection such that joining said working head with said handle assembly aligns said polygonal receptacle with said polygonal projection to provide an anti-rotational effect when in the locking position between the working head and said handle assembly.

6. The multi-purpose tool of claim 4 wherein said polygonal receptacle and polygonal projection are octagonal.

7. The multi-purpose tool of claim 5 wherein said polygonal receptacle and polygonal projection are octagonal.

8. The multi-purpose tool of claim 1 wherein said gripping arms and a portion of the attachment end defining the reduced diameter region are chamfered for facilitating a quick-connect locking connection.

9. The multi-purpose apparatus of claim 2 wherein said attachment end includes an upper chamfer and a lower chamfer, said lower chamfer facilitating a hands-free release of the working assembly upon movement of the trigger assembly to the second position.

10. The multi-purpose apparatus of claim 2 wherein said working member is a plunger.

11. The multi-purpose apparatus of claim 2 wherein said working member is a sponge.

12. The multi-purpose apparatus of claim 2 wherein said working member is a brush.

13. A multi-purpose cleaning tool comprising:
a handle member and a working member, the handle member receiving said working member in a locking connection in an attached condition and the handle member releasing said working member in a detached condition;
the handle member having first and second ends, said first end includes a gripping section for holding the cleaning tool by an operator, the handle member including a trigger assembly located near the gripping section and a receiving assembly positioned at said second end of said handle member for connecting with the working member, the receiving assembly including a pair of pivotally connected gripping arms connected to the trigger assembly through a link connection; and
the working member including a working end and an attachment assembly spaced opposite said working end, the attachment assembly including a shaft having a reduced diameter section engaged by said gripping arms to secure the working member to the handle member.

14. The multi-purpose cleaning tool of claim 13 further comprising a hub for connecting said gripping arms with said link, a stop projects from said hub and contacts said attachment assembly such that tolerances in said locking connection are controlled by the length of said stop.

15. The multi-purpose cleaning tool of claim 13 wherein said attachment assembly shaft includes a circular head defining the reduced section such that engagement by said gripping arms provides said locking connection, said gripping arms and said head having chamfered surfaces for providing a quick-connect type connection.

16. The multi-purpose cleaning tool of claim 13 wherein said working end is a selected one of a sponge, a brush, and a plunger.

17. A hand-held multi-purpose cleaning tool comprising:
a first member having a receiving assembly, handle section, and a trigger assembly, said trigger assembly being operatively located about said handle section;
a second member having an attachment end and a working end, when assembled said attachment end engages said receiving assembly of said first member to form a locking connection with said second member;
a central link for connecting said trigger assembly to said receiving assembly along a body segment of said first member, said receiving assembly comprising:
i. first and second pivotally mounted gripping arms having fingers for engaging said attachment end;
ii. a hub having an upper and lower portion, said upper portion connected to said central link and said lower portion pivotally connected to said gripping arms;
iii. a projection stop extending from said lower portion of said hub for engaging said attachment end;
iv. a polygonal shaped aperture for receiving said attachment end; and
v. a pair of cylinders integrally connected to said gripping arms and said hub such that actuation of the trigger assembly in a first direction causes translation of the central link resulting in outward pivotal movement of said gripping arms;
a circular head and polygonal projection extending from said attachment end, said polygonal projection engaging said polygonal shaped aperture forming an anti-rotational connection and said gripping arms engaging said circular head at a reduced diameter region to form said locking connection between said first and second members.

18. The hand-held multi-purpose cleaning tool of claim 17 wherein said working end is a sponge, brush, or plunger.

19. The hand-held multi-purpose cleaning and plunging tool of claim 17 wherein said trigger assembly further comprises a biasing member that forces the first and second pivotally mounted gripping arms in said locking connection.

20. The hand-held multi-purpose cleaning tool of claim 17 wherein said gripping arms and said head comprise chamfered surfaces for providing a quick-connect type connection.
